(19) United States
(12) Patent Application Publication
(10) Pub. No.: US 2002/0191024 A1
(43) Pub. Date: Dec. 19, 2002

(54) Utility metering slider bar

(76) Inventor: Timothy Huneycutt, Edmond, OK (US)

Correspondence Address: JOHN F. HAYDEN, Fish & Richardson P.C., 11th Floor, 1425 K. Steet, N.W., Washington, DC, 20005-3500, US

(21) Appl. No.: 10/165,990

(22) Filed: Jun. 11, 2002

Related U.S. Application Data
(60) Provisional application No. 60/297,444, filed on Jun. 13, 2001.
(60) Provisional application No. 60/318,868, filed on Sep. 14, 2001.
(60) Provisional application No. 60/318,869, filed on Sep. 14, 2001.

(51) Int. Cl. G09G 5/00

(52) U.S. Cl. 345/772

(57) ABSTRACT

Systems and techniques for displaying a graphical user interface. The graphical user interface includes a load profile of a customer and a slider bar. The slider bar is used to set a reduced peak demand level. Approximate potential savings are displayed to the customer at the reduced peak demand level.

### CROSS REFERENCE TO RELATED APPLICATIONS

This application claims priority to U.S. Provisional Application No. 60/297,444, titled “Utility Metering Slider Bar” and filed Jun. 13, 2001; U.S. Provisional Application No. 60/318,868, titled “Utility Capacity Transfer System” and filed Sep. 14, 2001; and U.S. Provisional Application No. 60/318,869, titled “Utility Monitoring and Management System” and filed Sep. 14, 2001. Each of these applications and U.S. application Ser. No. 09/828,170, titled “Electric Power Metering Package” and filed Apr. 9, 2001, is incorporated by reference.

### TECHNICAL FIELD

This invention relates to a graphical user interface, particularly a graphical user interface for analyzing utility consumption.

### BACKGROUND

In the utility industry, data acquisition and analysis systems are used to collect information about a customer's utility usage. Data about utility usage can be analyzed to determine a utility consumer's pattern of use over a time period, including the customer's peak usage, which may be known as a “load profile.” Load profiles may be created from a time series of utility consumption data. Load profiles may be determined for different time periods, such as, for example, a day, a week, or a year. Use of electricity, water, gas, and other utilities is generally greatest during daylight and business hours, but may also depend on other factors, such as weather or a customer's production schedule. A customer's future utility demand may be predicted by analyzing the customer's historical load profiles of utility usage, including load profiles detailing usage over different time scales. Historical load profiles may be used to predict a customer's pattern of utility usage on several different timescales, and the price of the utility may be adjusted according.

In deregulated utility markets, the price of a utility may vary on a short-term timescale. Since utility demand is generally greatest during the daylight hours of business days, but utility suppliers generally prefer to operate at a constant output rate, suppliers may charge different prices for utility consumption during peak and low demand periods. For example, electricity often is more expensive during daylight hours when businesses are operating, as opposed to nighttime hours.

A supplier may want to be able to anticipate fluctuating demand in order to allocate resources to meet the demand and also to be able to set demand-dependent rates in advance of the anticipated demand. By analyzing utility consumption data, suppliers can predict future demand, determine a price, and create an efficient market for the utility. For example, if a supplier predicts that demand for a utility will be high during a time period when the supply of the utility is low, the supplier may charge a premium rate and/or impose sever penalties on customers that use more than their allocated amount of the utility.

### SUMMARY

In one general aspect, a graphical user interface is displayed, the graphical user interface including a load profile of a customer and a slider bar. The slider bar is used to set a reduced peak demand level. Approximate potential savings are displayed to the customer at the reduced peak demand level.

Implementations may include one or more of the following features. For example, using the slider bar may include pulling down a horizontal line across the load profile from an actual peak demand level to the reduced peak demand level. The slider bar may configured so that the horizontal line is pulled down in fixed percentage intervals of the actual peak demand level. The graphical user interface may display utility reduction, time reduction, and/or utility-conserving actions necessary to achieve the reduced peak demand level.

These and other features may be used in the client-server model, as described, or in some other network connected computer environment. These features may be implemented using, for example, a method or a process, a device, an apparatus or a system, or software stored on a computer-readable medium.

Other features and advantages will become apparent from the description, the drawings, and the claims.

### DESCRIPTION OF DRAWINGS

FIG. 1 is a schematic diagram of a data collection and analysis system.

FIGS. 2-7 are graphical user interfaces that may be displayed by the data collection and analysis system of FIG. 1.

FIG. 8 is a schematic diagram of a computer system included in the data collection and analysis system of FIG. 1.

Like reference symbols in the various drawings indicate like elements.

### DETAILED DESCRIPTION

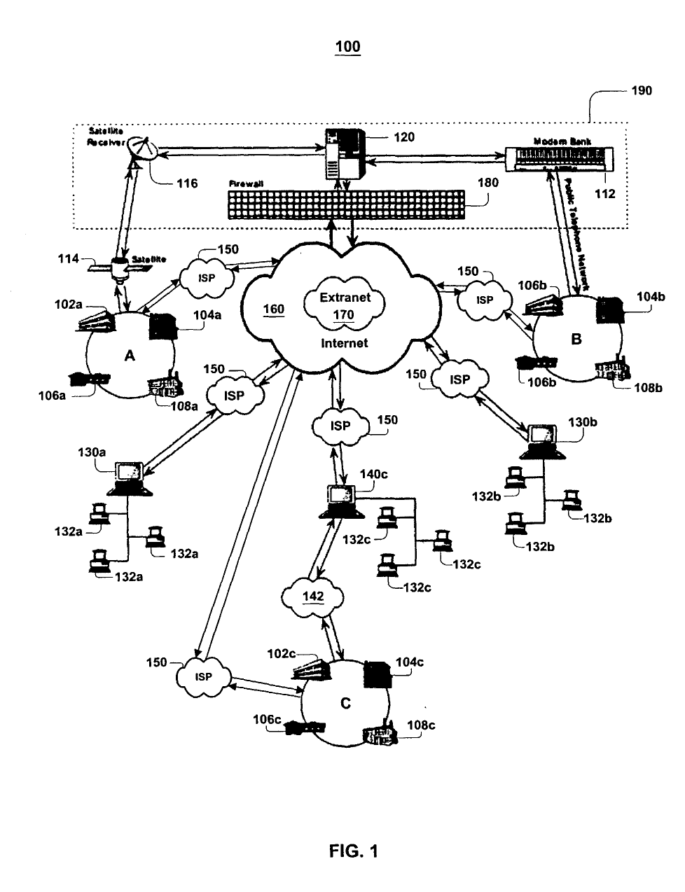

Referring to FIG. 1, a utility data collection and analysis system 100 includes clients in communication with a host 190. The data collection and analysis system 100 is capable of collecting and analyzing utility consumption data and may be configured for customer-specific applications. For example, the data collection and analysis system 100 may be implemented in-house by a utility company that collects and analyzes data about customers' utility usage from remote terminal units (“RTUs”) located at each customer's site. In another implementation, the data collection and analysis system 100 may be an outsource service company that collects and analyzes data about many different organizations' utility consumption and then provide access to the raw and processed data to the individual organizations it serves.

Different utility suppliers may serve different customers or utility consumers. For example, utility A may supply customers 102a, 104a, 106a, and 108a, and utility B may supply customers 102b, 104b, 106b, and 108b. Different utilities also may have their own client computers (e.g., 130a, 130b, 140c) for transmitting data to and from host 190 through the Internet 160. An individual utility also may run software applications 132a, 132b, 132c on client computers 130a, 130b, 130c for processing data pertaining to the individual utility or to the customers of the utility.

Clients, including utility suppliers (e.g., utility A, utility B, or utility C) and utility consumers (e.g., 102, 104, 106, 108), may login to host 190, which is protected by a firewall 180, through an Internet-enabled extranet 170 provided by the host. A user may be given selective access to data stored on host 190, such that the user is given access only to its own data, and the confidentiality of other users' data stored on host 190 is maintained. For example, utility A may be given selective access only to data concerning customers of utility A (e.g., 102a, 104a, 106a, and 108a), while utility B is given access only to data concerning customers of utility B (e.g., 102b, 104b, 106b, and 108b). Individual customers of a utility (e.g., 102a, 104a, 106a, 108a, 102b, 104b, 106b, 108b, 102c, 104c, 106c, and 108c) may be given selective access only to their own data, but not to data of other customers of the same utility or to data of the customers of other utilities. Selected data may be downloaded to the user from host 190 through an ISP 150 to the user's client computer 130.

Data acquisition and analysis may be provided through the host 190. The host 190 may be an Internet-enabled centralized system that receives utility usage data from meters and RTUs. Customers, utility suppliers, and other users of the service then may use the Internet to access the data and software to analyze, format, and display the data relevant to their needs from the host 190.

The host 190 may include equipment for receiving information from the clients, such as, for example, a modem bank 112 for receiving information transmitted over telephone or cable lines 110, or a satellite receiver 116 for receiving information over a wireless transmission link. Host 190 may include one or more server computers for receiving data from modem bank 112 or satellite receiver 116, storing the data, and for running software for processing the data, including sophisticated non-Internet enabled analysis software.

The host 190 may upload a variety of different data types from clients (e.g., suppliers and consumers). RTUs may be installed at a consumer's site to monitor utility consumption by a consumer, such as an office building 102, a production facility 104, a residence 106, or an apartment complex 108. RTUs may upload data from the customer's site directly to the host 190 through wired telephone links 110, via a satellite 114 over a wireless link, or over the Internet by sending the data to an Internet Service Provider (“ISP”) 150 that connects to the Internet 160 to send the data to the host 190. RTUs may also indirectly upload data from a customer to host 190, by first sending the data over a data transmission link 142 to the utility supplier's host computer 140 where it may be stored and/or processed before uploading it to host 190.

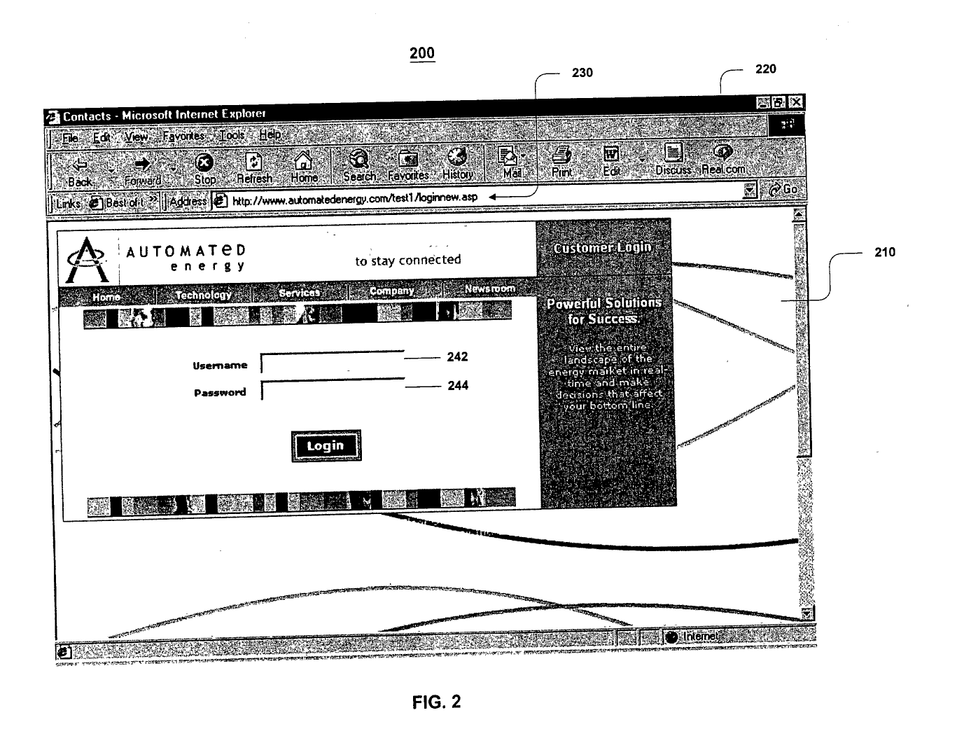

Referring to FIG. 2, users may log in to host 190 through a login screen 210 provided by an Internet-enabled user interface (“UI”) 200 of extranet 170. A user may use an Internet browser 220 (e.g., Microsoft's Internet Explorer or Netscape's Navigator) running on a client computer 130, 140 to access a login screen 210 by entering the uniform resource locator (“URL”) 230 of the login screen address in the browser interface. The user then may enter information, such as, for example, a predetermined username 242 and password 244 in order to gain access to the software applications and systems provided by host 190 through extranet 170.

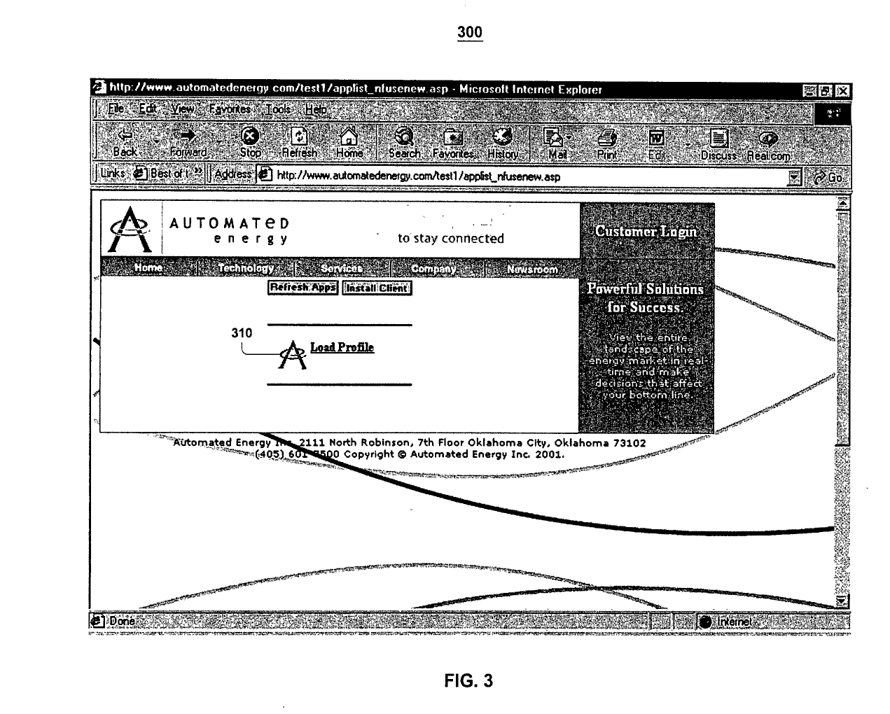

Referring to FIG. 3, once a user has successfully entered a username, password, and domain name to gain access to the extranet 170, an Internet-enabled UI 300 provide access to software applications displayed to the user. Icons 310 representing different software applications may be displayed to the user. The UI 300 may be implemented by an Internet-enabled framework, as described in U.S. application Ser. No. 09/828,170, which is incorporated by reference in its entirety.

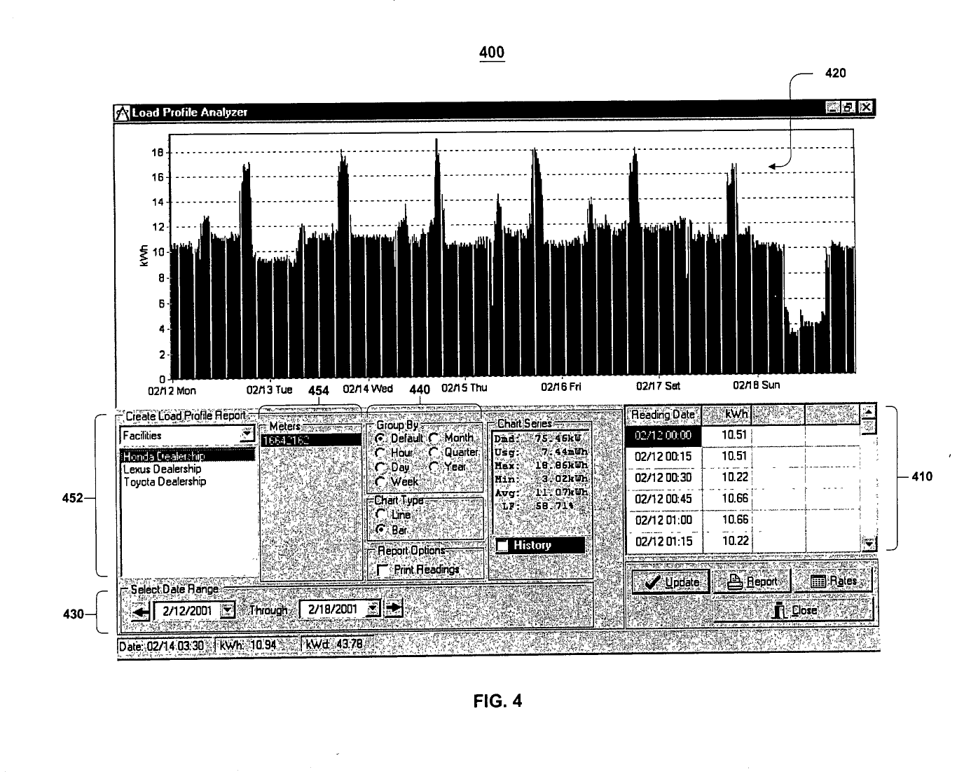

Referring to FIG. 4, a UI 400 is displayed by software application stored on host 190. The software application is accessible through extranet 170 and is capable of storing energy usage data retrieved from one or more RTUs. The energy usage data include a time series 410 recorded by one or more RTUs of energy consumed during regular intervals. The time series 410 is displayed graphically in the form of a load profile 420. Different time periods of the time series may be selected for graphical display by entering beginning and ending times for the display through the date range selection box 430. The format and density of points in the time series plot may be chosen from several predetermined formats 440. Load profiles may be created from data recorded by one or more RTUs. For example, load profiles may be created for different facilities 452, or for the data from different meters 454 at a facility according to the user's choice. Additionally, cumulative load profiles may be created from data derived from multiple RTUs. For example, load profiles tracking the utility consumption of a group of a customer's facilities, of a group of customers, of a geographic region, or of a group of sites served by a particular utility plant may be created and displayed.

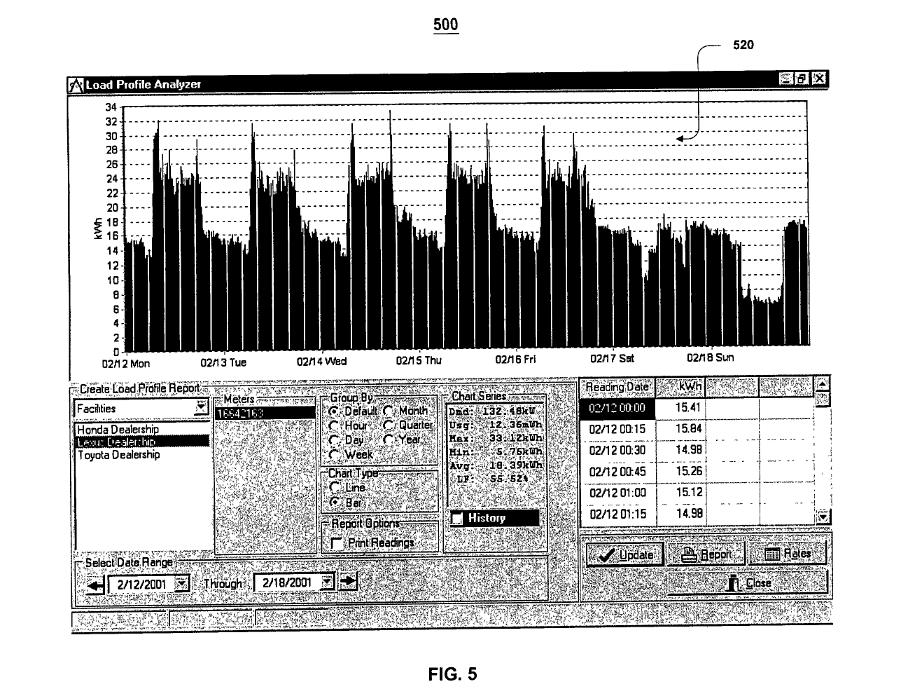

The load profile 420 displayed in FIG. 4 shows periodic maxima in the energy consumption at a Honda® Dealership occurring approximately between the hours of 4:00 and 8:00 pm, Monday through Saturday. Referring to FIG. 5, a UI 500 displays a load profile 520 for energy consumption at a Lexus® Dealership showing periodic maxima in energy consumption approximately between the hours of 7:00 am and 6:30 pm, Monday through Friday. If energy demand on a utility supplier is greatest, and therefore most expensive, during the middle of the day, for example, between 9:00 am and 3:00 pm, the Honda dealership may be able to negotiate an advantageous rate for the cost of its energy, because its periods of peak energy consumption are between 4:00 and 8:00 pm. Without the information contained in the time series data 410 and the load profile 420, the Honda dealership would generally have to purchase energy from a supplier based on its total energy consumption for a month, or based on its peak energy consumption during a period of time, and would not be able to benefit from the fact that its peak consumption occurs during low demand hours for the utility supplier. By analyzing its load profile using software stored on server 120 of host 190 through an extranet connection 170, the Honda dealership is able to demonstrate that its peak energy use does not occur between 9:00 am and 3:00 pm, which would generally benefit the dealership when negotiating a price for energy with the supplier. Of course, viewing the load profile is also valuable for the utility supplier, since it can adjust its rates for a particular customer based on the customer's usage pattern, and therefore can offer a competitive rate with respect to other utility suppliers with which it competes.

The load profile of the Lexus dealership shows that even though it uses most energy between the hours of 7:00 am and 6:30 pm, the dealership uses energy at an especially high rate approximately for an hour around 7:30 am and for a half hour around 5:30 pm. Thus, the information contained in the load profile for the Lexus dealership may be used to demonstrate that spikes in energy consumption generally do not occur during midday hours between 9:00 a.m. and 3:00 p.m.

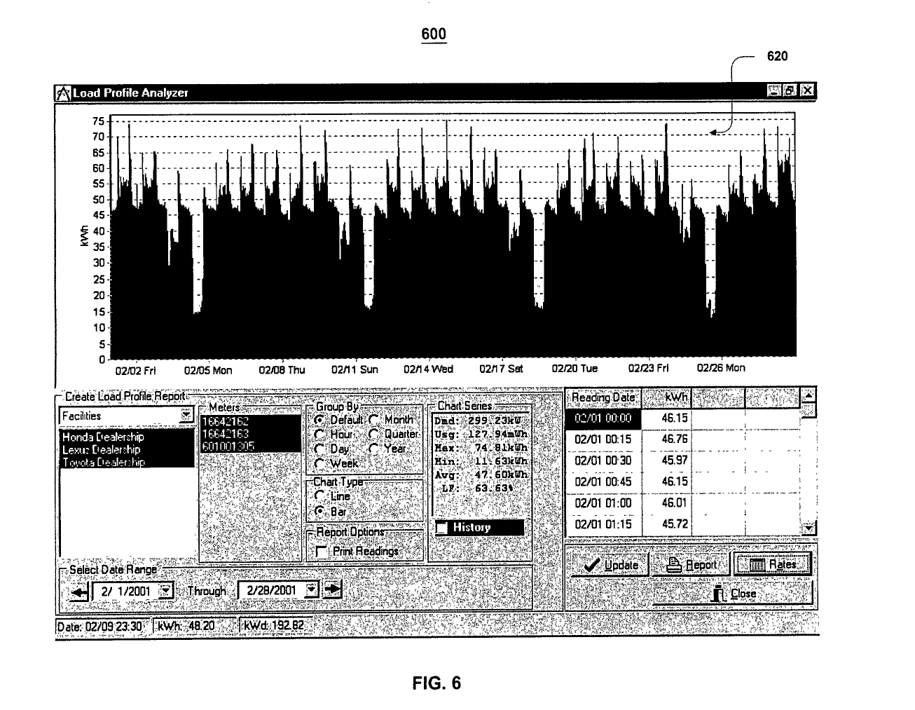

Referring to FIG. 6, a UI 600 displays an aggregate load profile 620 for energy consumption the Honda Dealership, Lexus® Dealership, and Toyota Dealership during the month of February 2001. Having aggregate information about a customer's utility consumption on a fine timescale (measured every hour, or every few minutes) is useful both to the utility supplier and to the utility consumer, as it permits them to negotiate a price for the utility in an efficient market. Load profiles for several different facilities may be analyzed, so that a customer may “package” facilities together in order to negotiate a package rate for the group. If some facilities use energy mostly at night and others generally consume energy during the day, their collective consumption may not vary greatly, which may be attractive for an energy supplier that wants to match a relatively constant supply to relatively constant demand. A utility supplier could offer price incentives to a customer who purchases the utility for the entire group, since the consumption of a large group generally fluctuates less than the consumption of an individual. Additionally, the utility supplier could offer incentives to encourage a group to use energy at a steady rate, with relatively low fluctuations.

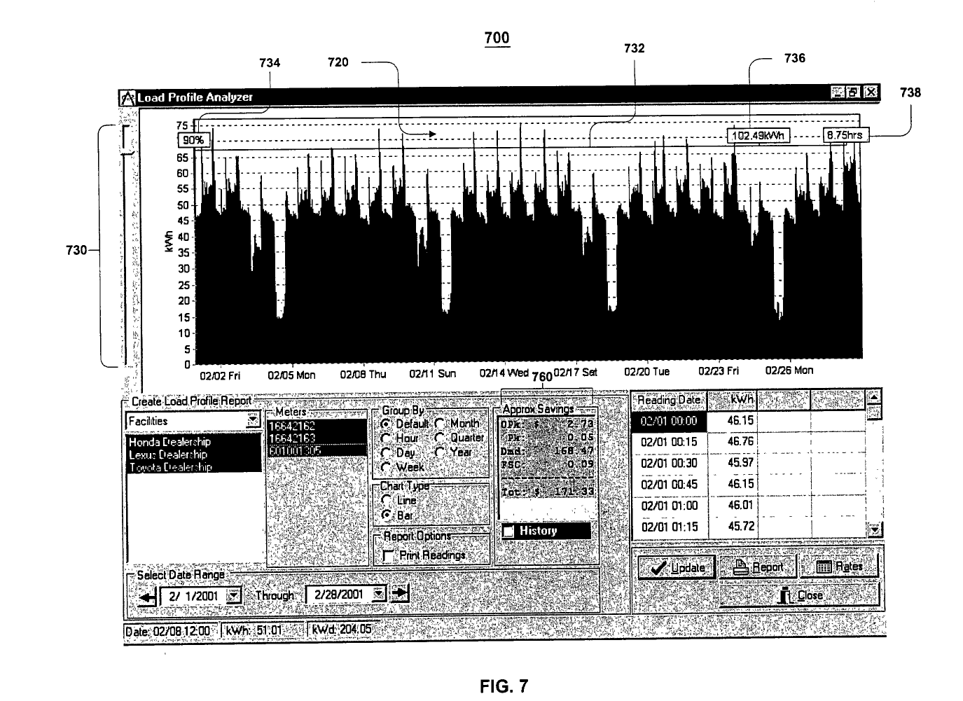

Referring to FIG. 7, a UI 700 displays a load profile 720 (e.g., aggregate load profile for several facilities). The UI 700 includes a slider bar user interface 730 that allows a user to pull down a horizontal line 732 across the load profile 720 at different levels. As the line 732 is pulled down, a utility management scenario and approximate cost savings are provided to the user.

For example, in the implementation shown in FIG. 7, the line 732 is configured to pull down in 5% intervals and has been pulled down by 10% to a reduced peak demand level of 90% for the given time period. The utility management scenario is displayed to the user by information boxes 734, 736, and 738. The information box 734 displays the reduced peak demand level (e.g., 90%). The information box 736 displays the corresponding utility reduction (e.g., 102.49 kWh) necessary to achieve the reduced peak demand level. The information box 738 displays the corresponding time reduction (e.g., 8.75 hours) necessary to achieve the reduced peak demand level. A savings window 760 displays the approximate cost savings (e.g., $171.33) resulting from institution of the energy management scenario.

In general, utility suppliers (e.g., power companies) charge customer for reserving capacity and may allocate resources and charge a price to a consumer based on the customer's peak demand. For example, a utility supplier may reserve capacity for a customer for an upcoming time interval (e.g., 12 months) based on the peak demand level for a past time interval (e.g., 12 months). If the customer exceeds the capacity level set by the energy supplier (i.e. the peak demand level) the utility supplier resets the capacity level to the new, higher peak demand, sets a new price, and often charges a penalty. Typically, once the customer establishes a peak, the utility supplier reserves capacity and the consumer must pay for the utility whether it is consumed or not. The utility supplier operates on the assumption that the customer at any time during the upcoming time interval may require the utility at the peak demand level and, therefore, reserves the capacity for the customer. The price charged by the utility supplier reflects reserved capacity at the peak demand level. Accordingly, it is in the customers' interest to avoid random spikes (i.e. short-term high utility use) in their load profile because even a one-time overuse of a utility may result in extended overpaying for a utility that is never consumed.

The UI 700 allows a consumer may to be able to anticipate demand in order to forecast utility expenses, and to alter a short-term utility usage pattern to reduce expenses, while maintaining a long-term total consumption level. With the energy management scenario, a customer can decide where and for how long to reduce utility consumption to achieve a desired cost savings. Customers having several facilities may take an across-the-board approach to utility management and/or target one or more specific facilities to realize the most benefit for the least amount of inconvenience. In short, customers can pick and choose how money for utility consumption is spent.

In a further implementation, the utility management scenario includes suggested actions to take in order to achieve the reduced peak demand level. For instance, the utility management scenario may suggest shutting down specified energy-consuming devices (e.g., generators, elevators, lights, air conditioners) in a particular facility for a certain period of time. The utility management scenario may suggest an enterprise-wide approach involving several different combinations of device and time reduction. The utility management scenario may include user preferences for customizing the suggested action to minimize total down time, minimize down time during normal business hours, minimize the total number of idle devices, minimize the number of idle devices during normal business hours, and/or otherwise minimize customer inconvenience.

The techniques, methods, and systems described here may find applicability in any computing or processing environment. Various implementations of the systems and techniques described here may be realized in digital electronic circuitry, or in computer hardware, firmware, software, or in combinations thereof. A system or other apparatus that uses one or more of the techniques and methods described here may be implemented as a computer-readable storage medium, configured with a computer program, where the storage medium so configured causes a computer system to operate on input and/or generate output in a specific and predefined manner. Such a computer system may include one or more programmable processors that receive data and instructions from, and transmit data and instructions to, a data storage system, and suitable input and output devices. Each computer program may be implemented in a high-level procedural or object-oriented programming language, or in assembly or machine language if desired; and in any case, the language may be a compiled or interpreted language. Suitable processors include, by way of example, both general and special purpose microprocessors.

Generally, a processor will receive instructions and data from a read-only memory and/or a random access memory. Storage devices suitable for tangibly embodying computer instructions and data include all forms of non-volatile memory, including semiconductor memory devices, such as EPROM, EEPROM, and flash memory devices; magnetic disks such as internal hard disks and removable disks; magneto-optical disks; and CD-ROM disks.

These elements also can be found in a desktop or workstation computer as well as other computers suitable for executing computer programs implementing the methods described here, which can be used in conjunction with any content viewing or manipulation software, or any other software capable of displaying portions of a larger body of content. Any of the foregoing may be supplemented by, or implemented in, specially designed ASICs (application specific integrated circuits).

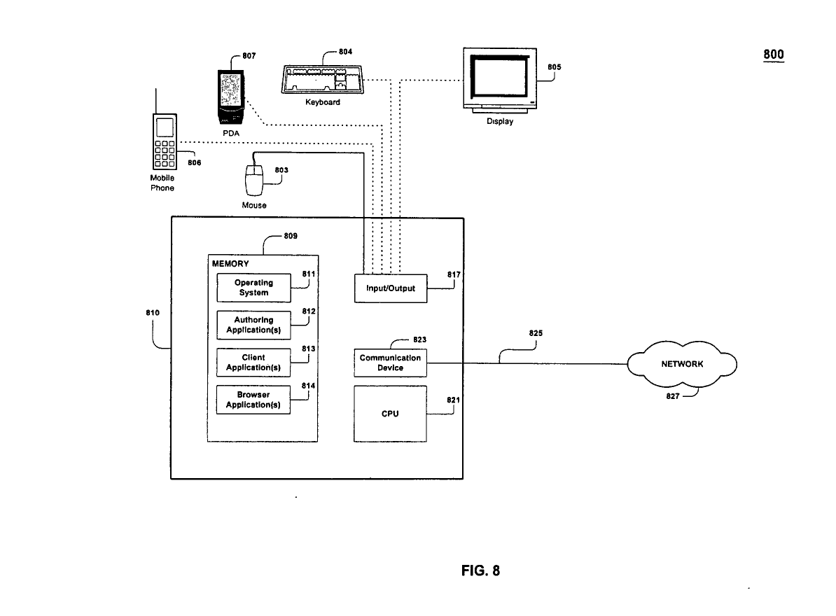

Referring to FIG. 8, a computer system 800 represents a hardware setup for executing software that allows a user to perform tasks such as sending, storing, viewing, editing, analyzing, retrieving, and downloading data, including utility consumption data. The computer system 800 of FIG. 8 may also be programmed with computer-readable instructions to enable data to be perceived as stored, viewed, edited, retrieve, downloaded, and otherwise manipulated.

The computer system includes various input/output (I/O) devices (mouse 803, keyboard 804, display 805, Internet-enabled mobile phone 806, and Internet-enabled PDA 806) and one or more general purpose computers 810 having a central processor unit (CPU) 821, an I/O unit 817 and a memory 809 that stores data and various programs such as an operating system 611, and one or more authoring applications 612 (e.g., programs for word processing, creating spread sheets, and producing graphics), one or more client applications 813 (e.g., programs for accessing online services), and one or more browser applications 814 (e.g., programs for retrieving and viewing electronic documents from the Internet and/or Web). The computer system 800 also includes a communications device 623 (e.g., a satellite receiver, a modem, or network adapter) for exchanging data with a network 627 through a communications link 625 (e.g., a telephone line and/or a wireless link).

A number of implementations have been described. Nevertheless, it will be understood that various modifications may be made. Accordingly, other implementations are within the scope of the following claims.

What is claimed is:

1. A method of utility management, the method comprising:
displaying a graphical user interface, the graphical user interface including a load profile of a customer and a slider bar;
using the slider bar to set a reduced peak demand level; and
displaying approximate potential savings to the customer at the reduced peak demand level.

2. The method of claim 1 wherein using the slider bar comprises pulling down a horizontal line across the load profile from an actual peak demand level to the reduced peak demand level.

3. The method of claim 2 wherein the horizontal line is configured to be pulled down in fixed percentage intervals of the actual peak demand level.

4. The method of claim 1 further comprising displaying a utility reduction necessary to achieve the reduced peak demand level.

5. The method of claim 1 further comprising displaying a time reduction necessary to achieve the reduced peak demand level.

6. The method of claim 5 further comprising suggesting utility-conserving actions to take to achieve the approximate potential cost savings.

7. A computer program, residing on a computer-readable storage medium for providing remote access to a software application for displaying utility data, the computer program comprising instructions to:
display a graphical user interface, the graphical user interface including a load profile of a customer and a slider bar;
receive commands through the slider bar to set a reduced peak demand level; and
display approximate potential savings to the customer at the reduced peak demand level.

8. The computer program of claim 7 further comprising instructions to display a utility reduction necessary to achieve the reduced peak demand level.

9. The computer program of claim 7 further comprising instructions to display a time reduction necessary to achieve the reduced peak demand level.

10. The computer program of claim 7 further comprising instructions to suggest utility-conserving actions to take to achieve the approximate potential cost savings.

11. A computer system for providing remote access to a software application for displaying utility data, the system comprising:
a host configured to interact with a client to display a graphical user interface, the graphical user interface including a load profile of a customer and a slider bar, wherein at least one of the host and the client receive commands through the slider bar to set a reduced peak demand level and display approximate potential savings to the customer at the reduced peak demand level.

12. A graphical user interface comprising:
a load profile of a customer; and
a slider bar configured to set a reduced peak demand level; and
a window for displaying approximate potential savings to the customer at the reduced peak demand level.
